(19) United States
(12) Patent Application Publication
(10) Pub. No.: US 2024/0320046 A1
(43) Pub. Date: Sep. 26, 2024

(54) THERMAL BALANCING SCHEDULER

(71) Applicant: QUALCOMM Innovation Center, Inc., San Diego, CA (US)

(72) Inventors: Ashay JAISWAL, Hyderabad (IN); Anirudh Ghayal, Secunderabad (IN); Taniya Das, Hyderabad (IN); Abhijeet Dharmapurikar, San Diego, CA (US); Stephen Paul Dickey, San Diego, CA (US)

(21) Appl. No.: 18/189,251

(22) Filed: Mar. 24, 2023

(51) Int. Cl. G06F 9/50

(52) U.S. Cl. CPC G06F 9/5027

(57) ABSTRACT

Systems and methods for thermally aware task scheduling and balancing are disclosed. One method includes receiving, from each of a plurality of temperature sensors, a temperature indication of a temperature of a corresponding processor cluster to obtain an indication of thermal conditions of a plurality of processor clusters and scheduling tasks to the plurality of processor clusters based upon the thermal conditions of the plurality of processor clusters. The frequency of each processor cluster is then scaled based upon the scheduled task load.

### BACKGROUND

### Field

The present disclosed embodiments relate generally to computing devices, and more specifically to control of processing cores in computing devices.

### Background

Computing devices including devices such as smartphones, tablet computers, gaming devices, and laptop computers are now ubiquitous. These computing devices are now capable of running a variety of applications (also referred to as “apps”) and many of these devices include multiple processors to process tasks that are associated with apps. In many instances, multiple processors are integrated as a collection of processor cores within a single functional subsystem.

It is known that the processing load on a mobile device may be apportioned to the multiple cores. As an example, for load balancing purposes, a processing task may be migrated from one core to another core. In addition, cores may be brought online, so the cores are available for use (e.g., by a scheduler, interrupt handlers, etc.), and cores may be taken offline so the cores are completely unavailable for any kind of work including processes and interrupts.

In current designs, thermal issues are mitigated by a system level thermal monitor, which does a flat frequency throttling once a thermal threshold is hit. But task schedulers available today are not aware of thermal conditions of the cores and do their task placement and frequency guidance independent of the thermal situation, which continues worsening the thermal conditions until the system monitored thermal throttling kicks in. This scheduler behavior results in a steady increase in the core/cluster heat, and eventually, the thermal threshold is hit, which causes the system thermal monitor to apply its frequency mitigation. This reactive thermal handling severely degrades the system performance.

### SUMMARY

In some aspects, the techniques described herein relate to a computing device including a plurality of processor clusters, wherein each processor cluster includes a temperature sensor. The computing device also includes a frequency governor configured to scale a frequency of each of the plurality of processor clusters and a thermal-balancing scheduler. The thermal-balancing scheduler is configured to receive, from each temperature sensor, a temperature indication that indicates a temperature of a corresponding processor cluster to obtain an indication of thermal conditions of the plurality of processor clusters. The thermal-balancing scheduler is also configured to schedule tasks to the plurality of processor clusters based upon the thermal conditions of the plurality of processor clusters and request the frequency governor to scale a frequency of one or more of the processor clusters based upon the scheduled tasks.

In other aspects, the techniques described herein relate to a method for scheduling tasks on a computing device. The method includes receiving, from each of a plurality of temperature sensors, a temperature indication of a temperature of a corresponding processor cluster to obtain an indication of thermal conditions of a plurality of processor clusters; scheduling tasks to the plurality of processor clusters based upon the thermal conditions of the plurality of processor clusters; and scaling a frequency of one or more of the plurality of processor clusters based upon a scheduled task load.

In yet other aspects, the techniques described herein relate to a non-transitory, tangible processor readable storage medium, encoded with processor readable instructions to perform a method for scheduling tasks on a computing device, the instructions including receiving, from each of a plurality of temperature sensors, a temperature indication of a temperature of a corresponding processor cluster to obtain an indication of thermal conditions of a plurality of processor clusters; scheduling tasks to the plurality of processor clusters based upon the thermal conditions of the plurality of processor clusters; and scaling a frequency of one or more of the plurality of processor clusters based upon a scheduled task load.

### BRIEF DESCRIPTION OF THE DRAWINGS

FIG. 1 is a block diagram illustrating components of a computing device;

FIG. 2 is a block diagram depicting an embodiment of the thermal-balancing scheduler depicted in FIG. 1;

FIG. 3 is a flow chart depicting a method that may be traversed in connection with embodiments disclosed herein; and

FIG. 4 is a block diagram depicting physical structures that may be utilized in connection with implementing the embodiments disclosed herein.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

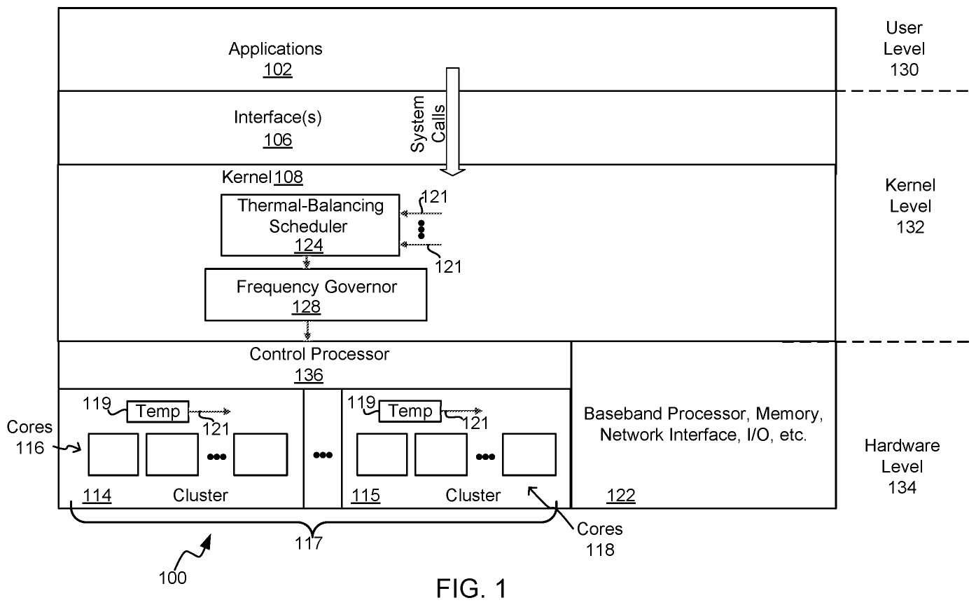

Referring to FIG. 1, it is a block diagram illustrating components of a computing device 100. The block diagram includes applications 102 at a highest level of abstraction and hardware 134, such as a first cluster 114 and a second cluster 115, at the lowest level. The first cluster 114 and the second cluster 115 are representative of a plurality of processor clusters 117 (e.g., N clusters where N is two or more). As shown, the first cluster 114 includes a first plurality of processor cores 116 and the second cluster 115 includes a second plurality of processing cores 118.

In many embodiments, the cores (e.g., cores 116) within a cluster (e.g., cluster 114) are homogeneous and synchronous (e.g., the cores have the same clock source). When the clusters in a system on a chip (SoC) are heterogeneous, some clusters may be considered power clusters (biased for lower power) and some clusters may be considered performance clusters (biased for performance). In the embodiment depicted in FIG. 1 for example, cluster 114 may be a power cluster and cluster 115 may be a performance cluster, but this is merely a non-limiting example.

The kernel 108, along with interface 106, enable communication between the applications 102 and the plurality of clusters 117. In particular, the interface 106 passes system calls from the applications 102 to the kernel 108, and the kernel 108 controls operations of the plurality of processor clusters 117 in connection with a control processor 136, which may function as an interface between the kernel 132 and the processor clusters 117 as those of ordinary skill in the art will appreciate. Also shown are temperature sensors 119 (where each temperature sensor 119 is thermally coupled to one of the of the plurality of processor clusters 117), and each of the temperature sensors 119 provides a temperature indication 121 that indicates a temperature of a corresponding one of the plurality of processor clusters 117. As shown, the thermal-balancing scheduler 124 receives, from each temperature sensor 119, a temperature indication 121 that indicates a temperature of a corresponding one of the processor clusters 117 to obtain an indication of thermal conditions of the plurality of processor clusters 117.

The applications 102 may be realized by a variety of applications that operate via, or run on, the processor clusters 117. For example, the one or more applications 102 may include a web browser and associated plug-ins, entertainment applications (e.g., video games, video players), productivity applications (e.g., word processing, spread sheet, publishing applications, video editing, photo editing applications), core applications (e.g., phone, contacts), and augmented reality applications.

As one of ordinary skill in the art will appreciate, the functionality of the user-level 130 and kernel-level 132 components depicted in FIG. 1 may be realized by hardware in connection with processor-executable code stored in a non-transitory tangible processor readable medium such as nonvolatile memory 122, and can be executed by a cluster (e.g., an app processor). Numerous variations on the embodiments herein disclosed are also possible. As shown, the kernel-level 132 includes a thermal-balancing scheduler 124 and a frequency governor 128.

The thermal-balancing scheduler 124 generally operates to schedule tasks among the plurality of processor clusters 117 based upon the thermal conditions of the plurality of processor clusters and the thermal-balancing scheduler 124 request the frequency governor 128 to scale a frequency of each of the processor clusters 117 based upon the scheduled tasks. The frequency governor 128 generally operates to scale the frequency of each of the processor clusters 117, based upon the scaling request from the thermal-balancing scheduler 124, by communicating frequency-scaling information to the control processor 136, and the control processor 136 controls the frequency of each of the processor clusters 117.

Thus, task placement and load balancing is performed by the thermal-balancing scheduler 124 with a thermal awareness that enables a thermal balance between the processor clusters 117 to be achieved. A resultant frequency requested by the frequency governor 128 for a cluster is directly related to the demand of tasks running on that cluster. And making the thermal-balancing scheduler 124 thermally aware while placing the tasks on different processor clusters 117 will alleviate thermal runaway of a hotter cluster—allowing the hotter cluster to cool down. This thermally-aware scheduling approach will also prevent a flat temperature threshold-based system mitigation; thus, maintaining an overall performance of the processor clusters 117.

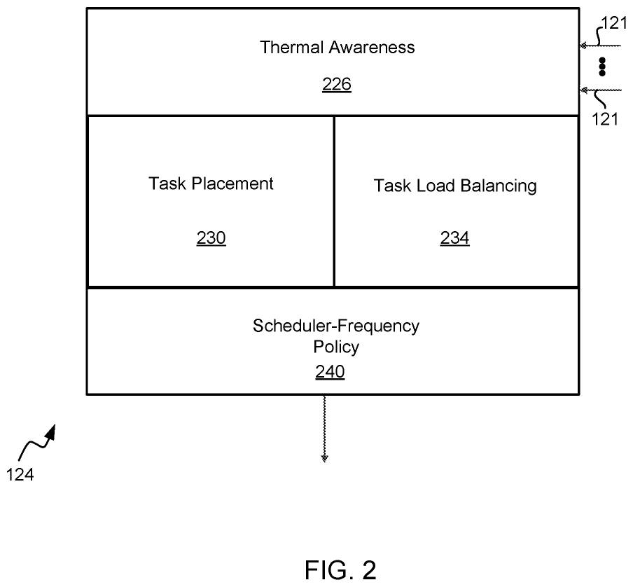

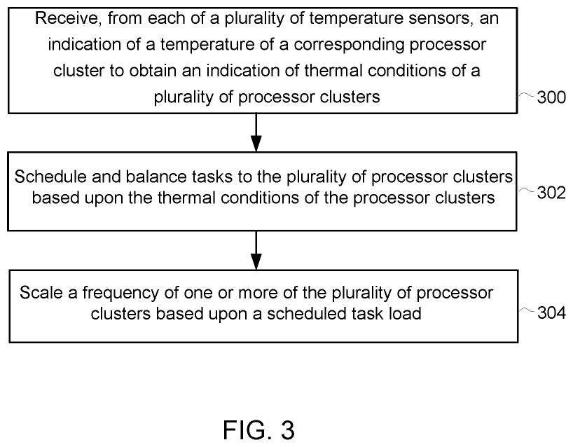

Referring next to FIG. 2, shown is a block diagram depicting an exemplary thermal-balancing scheduler 124 that may be used to realize the thermal-balancing scheduler 124 depicted in FIG. 1. As shown, the thermal-balancing scheduler 124 in this embodiment includes a thermal awareness module 226, a task placement module, a task load balancing module 234, and a schedular-frequency policy module 240. While referring to FIG. 2, simultaneous reference is made to FIG. 3, which is a flowchart depicting a method that may be traversed in connection with the embodiments depicted in FIGS. 1 and 2.

As shown, the thermal awareness module 226 is configured to receive, from each of the plurality of temperature sensors 119, a temperature indication 121 of a temperature of a corresponding processor cluster to obtain an indication of thermal conditions of a plurality of processor clusters 117 (Block 300). The task placement module 230 is configured to schedule tasks to the plurality of processor clusters 117 and the task load balancing module 234 is configured to balance the tasks among the plurality of processor clusters 117 based upon the thermal conditions of the processor clusters 117 (Block 302). In turn, the scheduler-frequency policy module 240 is configured to scale a frequency of one or more of the plurality of processor clusters 117 based upon the scheduled tasks (Block 304). More specifically, based upon the task load balancing, the scheduler-frequency policy module 240 applies a frequency to a cluster based upon a task load of each of the plurality of processor clusters 117. In this way, tasks may be scheduled to the plurality of processor clusters 117 to keep a thermal balance between the plurality of processor clusters 117.

Whenever a task comes up for placement (e.g., fork/cloned/wake) or load balancing is initiated at Block 302, the task placement module 230 and load balancing module 234 determines placement of a task based on cluster thermal state. Before detailing an example method that may be used to schedule and balance tasks at Block 302, it is helpful to identify and define a set of inputs and a set of states that may be utilized.

A maximum thermal threshold (Tₕₒₜ) of each of the processor clusters is defined as a threshold for each cluster where Tₕₒₜ triggers system level frequency throttling for the cluster.

A current temperature (Tⱼ) of a cluster is a temperature of one of the processor clusters 117 obtained from the temperature indication 121 from a temperature sensor 119.

And the following states may be defined:

Tₕₒₜ: beyond this maximum thermal threshold, a system thermal monitory applies flat frequency mitigation.

T_{mitigate}: This is (Tₕₒₜ−X) and once a cluster's temperature crosses this first threshold, the thermal-balancing scheduler 124 starts applying placement policy to place a task on a cooler cluster.

T_{migrate}: This is (Tₕₒₜ−Y) and once a cluster's temperature crosses this second threshold (where the second threshold is a higher temperature than the first threshold), the thermal-balancing scheduler 124 starts migrating tasks from the hotter cluster to cooler cluster. Where X and Y are temperature offsets and X is greater than Y.

With these inputs and states defined, each of the plurality of processor clusters may be characterized with one of a plurality of thermal states. Table 1 provides an example, without limitation, of a plurality of thermal states that may be utilized to characterize each of the processor clusters 117:

TABLE 1

| Cluster State | Thermal condition |
|---|---|
| COOL | Tⱼ is less than T_{mitigate} |
| WARM | T_{mitigate} < Tⱼ < T_{mitigate} |
| HOT | T_{mitigate} < Tⱼ < Tₕₒₜ |

Based upon the thermal states, thermal-balancing scheduler 124 is configured to characterize each of the plurality of processor clusters 117 as either a cool cluster, a warm cluster, or a hot cluster in the groups shown in Table 2:

TABLE 2

| | |
|---|---|
| COOL group | List of all the clusters in cool thermal state. |
| WARM group | List of all the clusters in warm thermal state. |
| HOT group | List of all the clusters in hot thermal state. |

In view of the inputs, states, and groups identified above, the task placement module 230 or load balancing module 234 may apply a thermal policy for a computing device with N clusters (C1 to CN). Table 3 below provides an example of a thermal policy that may be applied by the task load balancing module 234:

TABLE 3

| Cluster group state | Scheduler behavior | Impact |
|---|---|---|
| COOL {C₁ . . . C_{N}} | As all clusters are in COOL group. | NA |
| WARM { } | Default scheduler behavior on task | |
| HOT { } | placement and load balancing. | |
| COOL { } | Task Placement: | Reducing task load |
| WARM { } | For any new or existing task that needs | on clusters which |
| HOT {C₁ . . . C_{N}} | to be scheduled, select the cluster within | are closest to their |
| | HOT groups which is farthest from its | mitigation threshold |
| | maximum thermal threshold Tₕₒₜ. | (Tₕₒₜ). thus allowing |
| | Load Balancing (within HOT group): | hottest clusters |
| | Avoid migration of task towards clusters | within HOT group |
| | which are closer to their maximum | to cool down. |
| | thermal threshold Tₕₒₜ. | |
| COOL { } | Task Placement: | Reducing task load |
| WARM {C₁ . . . C_{N}} | For any new or existing task that needs | on clusters which |
| HOT { } | to be scheduled, select the cluster within | are closest to their |
| | WARM groups which is farthest from | mitigation threshold |
| | its maximum thermal threshold Tₕₒₜ. | (Tₕₒₜ) thus allowing |
| | Load Balancing (within WARM | hottest clusters |
| | group): | within WARM |
| | Avoid migration of task towards clusters | group to cool down. |
| | which are closer to their maximum | |
| | thermal threshold Tₕₒₜ. | |
| COOL { } | Task Placement: | Reduce task load on |
| WARM {C₁ . . . C_{J}} | For any new or existing task that needs | HOT cluster as all |
| HOT {C_{J+1} . . . C_{N}} | to be scheduled, select the cluster in | new or waking task |
| | WARM groups which is farthest from | will be placed on |
| | its maximum thermal threshold Tₕₒₜ. | WARM cluster |
| | Loading Balancing: | group. |
| | Avoid migration of tasks from WARM | Thus, prevent any |
| | clusters to HOT cluster. | further thermal |
| | Within WARM cluster avoid migration | runaway of HOT |
| | of task towards WARM clusters which | clusters. |
| | are closer to their maximum thermal | |
| | threshold Tₕₒₜ. | |
| COOL {C₁ . . . C_{J}} | Task Placement: | No new task load on |
| WARM { } | For any new or existing task that needs | HOT cluster. |
| HOT {C_{J+1} . . . C_{N}} | to be scheduled, select the cluster in | Reduce task load on |
| | COOL group. | HOT cluster by |
| | Loading Balancing: | initiating migration |
| | Avoid migration of tasks to from COOL | of task from HOT |
| | to HOT cluster. | cluster group. |
| | Identify the hottest cluster in the HOT | Thus, allowing HOT |
| | groups and initiate active task migration | clusters to cool |
| | from that clusters towards cluster in | down and prevent |
| | COOL group. | any further thermal |
| | | runaway of HOT |
| | | clusters. |
| COOL {C₁ . . . C_{J}} | Task Placement: | No new task load on |
| WARM {C_{J+1} . . . C_{N}} | For any new or existing task that needs | WARM cluster. |
| HOT { } | to be scheduled, select the cluster in | Thus, allowing |
| | COOL group. | WARM clusters to |
| | Loading Balancing: | cool down and |
| | Avoid migration of tasks to COOL to | prevent further |
| | WARM cluster. | thermal run-away on |
| | | WARM cluster. |
| COOL {C₁ . . . C_{J}} | Task Placement: | No new task load on |
| WARM {C_{K+1} . . . C_{K}} | For any new or existing task that needs | WARM/HOT |
| HOT {C_{K+1} . . . C_{N}} | to be scheduled, select the cluster in | cluster. |
| | COOL group. | Prevent further |
| | Loading Balancing: | thermal run-away on |
| | Avoid migration of tasks to HOT | WARM & HOT |
| | cluster. | cluster. |
| | Avoid migration of tasks to COOL to | |
| | WARM cluster. | |
| | Identify the hottest cluster in the HOT | |
| | groups and initiate active task migration | |
| | from that clusters towards cluster in | |
| | COOL group. | |

As shown, the task scheduling includes scheduling tasks based upon the thermal conditions of the processor clusters 117 when any processor cluster is either a hot cluster or warm cluster, and scheduling tasks independently of the thermal conditions of the processor clusters 117 when all processor clusters are in cool cluster group. But when all of the processor clusters 117 are either hot clusters or all of the processor clusters 117 are warm clusters, then a processor cluster is selected that has a temperature that is farthest from its maximum thermal threshold, Tₕₒₜ, for any new or existing task that needs to be scheduled, and task migration towards any processor cluster which is closer to its maximum thermal threshold, Tₕₒₜ, is prevented.

When one or more of the processor clusters 117 are warm clusters, one or more of the processor clusters are hot clusters, and none of the processor clusters are cool clusters, then a warm cluster is selected which has a temperature that is farthest from its maximum thermal threshold, Tₕₒₜ, for any new or existing task that needs to be scheduled, and task migration from a warm cluster to a hot cluster is prevented. In addition, task migration from a warm cluster to another warm cluster that is closer to its maximum thermal threshold, Tₕₒₜ, is prevented.

When one or more of the processor clusters 117 are cool clusters, one or more of the processor clusters 117 are hot clusters, and none of the processor clusters are warm clusters, then a cool cluster is selected for any new or existing task that needs to be scheduled, and task migration from a cool cluster to a hot cluster is prevented while active task migration from the hottest cluster toward any cool cluster is carried out.

When one or more of the processor clusters 117 are cool clusters, one or more of the processor clusters 117 are warm clusters, and none of the processor clusters 117 are hot clusters, a cool cluster is selected for any new or existing task that needs to be scheduled, and task migration from a cool cluster to a warm cluster is prevented.

When one or more of the processor clusters 117 are cool clusters, one or more of the processor clusters 117 are warm clusters, and one or more of the processor clusters 117 are hot clusters, task migration to a hot cluster is prevented, task migration from a cool cluster to a warm cluster is prevented, active task migration from the hottest cluster toward any cool cluster is initiated.

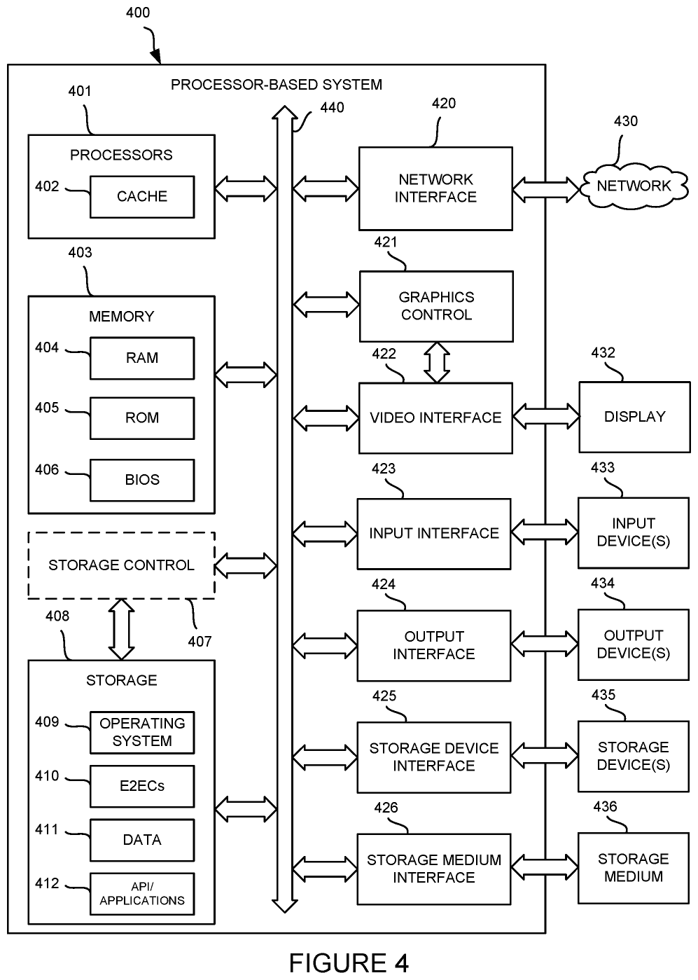

The systems and methods described herein can be implemented in a machine such as a processor-based system in addition to the specific physical devices described herein. FIG. 4 shows a diagrammatic representation of one embodiment of a machine in the exemplary form of a processor-based system 400 within which a set of processor readable instructions (stored in a non-transitory, tangible processor readable storage medium) can execute for causing a device to perform or execute any one or more of the aspects and/or methodologies of the present disclosure. The components in FIG. 4 are examples only and do not limit the scope of use or functionality of any hardware, software, embedded logic component, or a combination of two or more such components implementing particular embodiments.

Processor-based system 400 may include processors 401, a memory 403, and storage 408 that communicate with each other, and with other components, via a bus 440. The bus 440 may also link a display 432 (e.g., touch screen display), input interface 423, output interface 424, one or more input devices 433 (which may, for example, include a keypad, a keyboard, a mouse, a stylus, etc.), one or more output devices 434, one or more storage devices 435, and various non-transient, tangible storage media 436. All of these elements may interface directly or via one or more interfaces or adaptors to the bus 440. For instance, the various non-transitory tangible storage media 436 can interface with the bus 440 via storage medium interface 426. Processor-based system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processors 401 (or central processing unit(s) (CPU(s))) optionally contain a cache memory unit 402 for temporary local storage of instructions, data, or computer addresses. Processor(s) 401 are configured to assist in execution of processor-executable instructions. Processor-based system 400 may provide functionality as a result of the processor(s) 401 executing software embodied in one or more tangible processor-readable storage media, such as memory 403, storage 408, storage devices 435, and/or storage medium 436. The processor-readable media may store software that implements particular embodiments, and processor(s) 401 may execute the software. Each of the processors may include multiple cores, and the cores may be organized as processor clusters 117. Memory 403 may read the software from one or more other processor-readable media (such as mass storage device(s) 435, 436) or from one or more other sources through a suitable interface, such as network interface 420. The software may cause processor(s) 401 to carry out one or more processes or one or more steps of one or more processes described or illustrated herein for scheduling and tasks and thermally-aware task load balancing. Carrying out such processes or steps may include defining data structures stored in memory 403 and modifying the data structures as directed by the software.

The memory 403 may include various components (e.g., machine readable media) including, but not limited to, a random access memory component (e.g., RAM 404) (e.g., a static RAM “SRAM”, a dynamic RAM “DRAM, etc.), a read-only component (e.g., ROM 405)(which may be described as a non-transitory, tangible processor readable storage medium that stores processor readable instructions), and any combinations thereof. ROM 405 may act to communicate data and instructions unidirectionally to processor(s) 401, and RAM 404 may act to communicate data and instructions bidirectionally with processor clusters 117. ROM 405 and RAM 404 may include any suitable tangible processor-readable media described below. In one example, a basic input/output system 406 (BIOS), including basic routines that help to transfer information between elements within processor-based system 400, such as during start-up, may be stored in the memory 403.

Fixed storage 408 is connected bidirectionally to processor(s) 401, optionally through storage control unit 407. Fixed storage 408 provides additional data storage capacity and may also include any suitable tangible processor-readable media described herein. Storage 408 may be used to store operating system 409, EXECs 410 (executables), data 411, APV applications 412 (application programs), and the like. Often, although not always, storage 408 is a secondary storage medium (such as a hard disk) that is slower than primary storage (e.g., memory 403). Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with processor-based system 400 (e.g., via an external port connector (not shown)) via a storage device interface 425. Particularly, storage device(s) 435 and an associated machine-readable medium may provide nonvolatile and/or volatile storage of processor-executable instructions, data structures, program modules, and/or other data for the processor-based system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures.

Processor-based system 400 may also include an input device 433. In one example, a user of processor-based system 400 may enter commands and/or other information into processor-based system 400 via input device(s) 433. Examples of an input device(s) 433 include, but are not limited to, an alpha-numeric input device (e.g., a keyboard), a pointing device (e.g., a mouse or touchpad), a touchpad, a joystick, a gamepad, an audio input device (e.g., a microphone, a voice response system, etc.), an optical scanner, a video or still image capture device (e.g., a camera), and any combinations thereof.

In particular embodiments, when processor-based system is connected to network 430, processor-based system 400 may communicate with other devices, specifically mobile devices and enterprise systems, connected to network 430. Communications to and from processor-based system 400 may be sent through network interface 420. For example, network interface may receive incoming communications (such as requests or responses from other devices) in the form of one or more packets (such as Internet Protocol (IP) packets) from network 430, and computing device 100 may store the incoming communications in memory 403 for processing. Processor-based system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 430, may employ a wired and/or a wireless mode of communication. In general, any network topology may be used.

Information and data can be displayed through a display 432. Examples of a display 432 include, but are not limited to, a liquid crystal display (LCD), an organic liquid crystal display (OLED), a cathode ray tube (CRT), a plasma display, and any combinations thereof. The display 432 can interface to the processor(s) 401, memory 403, and fixed storage 408, as well as other devices, such as input device(s), via the bus 440. The display 432 is linked to the bus 440 via a video interface 422, and transport of data between the display 432 and the bus 440 can be controlled via the graphics control 421.

In addition or as an alternative, processor-based system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a processor-readable medium may encompass a circuit (such as an IC) storing software for execution, a circuit embodying logic for execution, or both, where appropriate. The present disclosure encompasses any suitable combination of hardware or software in connection with hardware.

Those of skill would further appreciate that the various illustrative logical blocks, modules, circuits, and algorithm steps described in connection with the embodiments disclosed herein may be implemented as electronic hardware, or hardware in connection with software. Various illustrative components, blocks, modules, circuits, and steps have been described above generally in terms of their functionality. Whether such functionality is implemented as hardware or hardware that utilizes software depends upon the particular application and design constraints imposed on the overall system. Skilled artisans may implement the described functionality in varying ways for each particular application, but such implementation decisions should not be interpreted as causing a departure from the scope of the present invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computing device comprising:
a plurality of processor clusters, each processor cluster comprising a temperature sensor;
a frequency governor configured to scale a frequency of each of the plurality of processor clusters; and
a thermal-balancing scheduler configured to:
receive, from each temperature sensor, a temperature indication that indicates a temperature of a corresponding processor cluster to obtain an indication of thermal conditions of the plurality of processor clusters;
schedule tasks to the plurality of processor clusters based upon the thermal conditions of the plurality of processor clusters; and
request the frequency governor to scale a frequency of one or more of the plurality processor clusters based upon the scheduled tasks.

2. The computing device of claim 1, wherein the thermal-balancing scheduler is configured to schedule tasks to the plurality of processor clusters to keep a thermal balance between the plurality of processor clusters.

3. The computing device of claim 1, wherein the thermal-balancing scheduler is configured to characterize each of the plurality of processor clusters as one of a plurality of thermal states and the thermal-balancing scheduler is configured to schedule tasks based upon the thermal states of the plurality of processor clusters.

4. The computing device of claim 1, wherein the thermal-balancing scheduler is configured to:
characterize each of the plurality of processor clusters as either a cool cluster, a warm cluster, or a hot cluster;
wherein each cool cluster has a temperature that is less than a first threshold;
wherein each warm cluster has a temperature that is greater than the first threshold but is less than a second threshold;
wherein each hot cluster has a temperature that is greater than the second threshold;
wherein the second threshold is a higher temperature than the first threshold and the second threshold is less than a maximum thermal threshold where the maximum thermal threshold triggers frequency throttling; and
wherein the thermal-balancing scheduler schedules tasks based upon the thermal conditions of the plurality of processor clusters when any processor cluster is either a hot cluster or a warm cluster, and wherein the thermal-balancing scheduler schedules tasks independently of the thermal conditions of the plurality of processor clusters when all of the plurality of processor clusters are cool clusters.

5. The computing device of claim 4, wherein the thermal-balancing scheduler is configured to, when either all of the plurality of processor clusters are hot clusters or all of the plurality of processor clusters are warm clusters:
select a processor cluster which has a temperature that is farthest from its maximum thermal threshold for any new or existing task that needs to be scheduled; and
prevent task migration towards any processor cluster which is closer to its maximum thermal threshold.

6. The computing device of claim 4, wherein the thermal-balancing scheduler is configured to, when one or more of the plurality of processor clusters are warm clusters, one or more of the plurality of processor clusters are hot clusters, and none of the plurality of processor clusters are cool clusters:
select a warm cluster which has a temperature that is farthest from its maximum thermal threshold, for any new or existing task that needs to be scheduled; and
prevent task migration from a warm cluster to a hot cluster; and
prevent task migration from a warm cluster to another warm cluster that is closer to its maximum thermal threshold.

7. The computing device of claim 4, wherein the thermal-balancing scheduler is configured to, when one or more of the plurality of processor clusters are cool clusters, one or more of the plurality of processor clusters are hot clusters, and none of the plurality of processor clusters are warm clusters:
select a cool cluster for any new or existing task that needs to be scheduled; and
prevent task migration from a cool cluster to a hot cluster; and
identify a hottest cluster and initiate active task migration from the hottest cluster toward any cool cluster.

8. The computing device of claim 4, wherein the thermal-balancing scheduler is configured to, when one or more of the plurality of processor clusters are cool clusters, one or more of the plurality of processor clusters are warm clusters, and none of the plurality of processor clusters are hot clusters:
select a cool cluster for any new or existing task that needs to be scheduled; and
prevent task migration from a cool cluster to a warm cluster.

9. The computing device of claim 4, wherein the thermal-balancing scheduler is configured to, when one or more of the plurality of processor clusters are cool clusters, one or more of the plurality of processor clusters are warm clusters, and one or more of the plurality of processor clusters are hot clusters:
prevent task migration to a hot cluster;
prevent task migration from a cool cluster to a warm cluster; and
identify a hottest cluster and initiate active task migration from the hottest cluster toward any cool cluster.

10. A method for scheduling tasks on a computing device, the method comprising:
receiving, from each of a plurality of temperature sensors, a temperature indication of a temperature of a corresponding processor cluster to obtain an indication of thermal conditions of a plurality of processor clusters;
scheduling tasks to the plurality of processor clusters based upon the thermal conditions of the plurality of processor clusters; and
scaling a frequency of one or more of the plurality of processor clusters based upon a scheduled task load.

11. The method of claim 10, further comprising scheduling tasks to the plurality of processor clusters to keep a thermal balance between the plurality of processor clusters.

12. The method of claim 10 further comprising:
characterizing each of the plurality of processor clusters as one of a plurality of thermal states; and
scheduling tasks based upon the thermal states of the plurality of processor clusters.

13. The method of claim 10, further comprising:
characterizing each of the plurality of processor clusters as either a cool cluster, a warm cluster, or a hot cluster;
wherein each cool cluster has a temperature that is less than a first threshold;
wherein each warm cluster has a temperature that is greater than the first threshold, but is less than a second threshold;
wherein each hot cluster has a temperature that is greater than the second threshold;
wherein the second threshold is a higher temperature than the first threshold and the second threshold is less than a maximum thermal threshold where the maximum thermal threshold triggers frequency throttling; and
wherein scheduling tasks comprises scheduling tasks based upon the thermal conditions of the plurality of processor clusters when any processor cluster is either a hot cluster or a warm cluster and scheduling tasks independently of the thermal conditions of the plurality of processor clusters when all of the plurality of processor clusters are cool clusters.

14. The method of claim 13, further comprising, when either all of the plurality of processor clusters are hot clusters or all of the plurality of processor clusters are warm clusters:
selecting a processor cluster which has a temperature that is farthest from its maximum thermal threshold for any new or existing task that needs to be scheduled; and
preventing task migration towards any processor cluster which is closer to its maximum thermal threshold.

15. The method of claim 13, further comprising, when one or more of the plurality of processor clusters are warm clusters, one or more of the plurality of processor clusters are hot clusters, and none of the plurality of processor clusters are cool clusters:
selecting a warm cluster which has a temperature that is farthest from its maximum thermal threshold for any new or existing task that needs to be scheduled; and
preventing task migration from a warm cluster to a hot cluster; and
preventing task migration from a warm cluster to another warm cluster that is closer to its maximum thermal threshold.

16. The method of claim 13, further comprising, when one or more of the plurality of processor clusters are cool clusters, one or more of the plurality of processor clusters are hot clusters, and none of the plurality of processor clusters are warm clusters:
selecting a cool cluster for any new or existing task that needs to be scheduled; and
preventing task migration from a cool cluster to a hot cluster; and
identifying a hottest cluster and initiating active task migration from the hottest cluster toward any cool cluster.

17. The method of claim 13, further comprising, when one or more of the plurality of processor clusters are cool clusters, one or more of the plurality of processor clusters are warm clusters, and none of the plurality of processor clusters are hot clusters:
selecting a cool cluster for any new or existing task that needs to be scheduled; and
prevent task migration from a cool cluster to a warm cluster.

18. The method of claim 13, further comprising, when one or more of the plurality of processor clusters are cool clusters, one or more of the plurality of processor clusters are warm clusters, and one or more of the plurality of processor clusters are hot clusters:
selecting a cool cluster for any new or existing task that needs to be scheduled;
preventing task migration to a hot cluster;
preventing task migration from a cool cluster to a warm cluster; and
identifying a hottest cluster and initiating active task migration from the hottest cluster toward any cool cluster.

19. A non-transitory, tangible processor readable storage medium, encoded with processor readable instructions to perform a method for scheduling tasks on a computing device, the instructions comprising:
receiving, from each of a plurality of temperature sensors, a temperature indication of a temperature of a corresponding processor cluster to obtain an indication of thermal conditions of a plurality of processor clusters;
scheduling tasks to the plurality of processor clusters based upon the thermal conditions of the plurality of processor clusters; and
scaling a frequency of each processor cluster based upon a scheduled task load.

20. The non-transitory, tangible processor readable storage medium of claim 19, wherein the instructions further comprise instructions to schedule tasks to the plurality of processor clusters to keep a thermal balance between the plurality of processor clusters.

21. The non-transitory, tangible processor readable storage medium of claim 19, the instructions further comprising instructions for:
characterizing each of the plurality of processor clusters as one of a plurality of thermal states; and
scheduling tasks based upon the thermal states of the plurality of processor clusters.

22. The non-transitory, tangible processor readable storage medium of claim 19, the instructions further comprising:
characterizing each of the plurality of processor clusters as either a cool cluster, a warm cluster, or a hot cluster;
wherein each cool cluster has a temperature that is less than a first threshold;
wherein each warm cluster has a temperature that is greater than the first threshold but is less than a second threshold;
wherein each hot cluster has a temperature that is greater than the second threshold;
wherein the second threshold is a higher temperature than the first threshold and the second threshold is less than a maximum thermal threshold where the maximum thermal threshold triggers frequency throttling; and
wherein scheduling tasks comprises scheduling tasks based upon the thermal conditions of the plurality of processor clusters when any processor cluster is either a hot cluster or a warm cluster and scheduling tasks independently of the thermal conditions of the processor clusters when all of the plurality of processor clusters are cool clusters.

23. The non-transitory, tangible processor readable storage medium of claim 22, the instructions further comprising, when either all of the plurality of processor clusters are hot clusters or all of the plurality of processor clusters are warm clusters:
selecting a processor cluster which has a temperature that is farthest from its maximum thermal threshold for any new or existing task that needs to be scheduled; and
preventing task migration towards any processor cluster which is closer to its maximum thermal threshold.

24. The non-transitory, tangible processor readable storage medium of claim 22, the instructions further comprising, when one or more of the plurality of processor clusters are warm clusters, one or more of the plurality of processor clusters are hot clusters, and none of the plurality of processor clusters are cool clusters:
selecting a warm cluster which has a temperature that is farthest from its maximum thermal threshold for any new or existing task that needs to be scheduled; and
preventing task migration from a warm cluster to a hot cluster; and
preventing task migration from a warm cluster to another warm cluster that is closer to its maximum thermal threshold.

25. The non-transitory, tangible processor readable storage medium of claim 22, the instructions further comprising, when one or more of the plurality of processor clusters are cool clusters, one or more of the plurality of processor clusters are hot clusters, and none of the plurality of processor clusters are warm clusters:
selecting a cool cluster for any new or existing task that needs to be scheduled; and
preventing task migration from a cool cluster to a hot cluster; and
identifying a hottest cluster and initiating active task migration from the hottest cluster toward any cool cluster.

26. The non-transitory, tangible processor readable storage medium of claim 22, the instructions further comprising, when one or more of the plurality of processor clusters are cool clusters, one or more of the plurality of processor clusters are warm clusters, and none of the plurality of processor clusters are hot clusters:
selecting a cool cluster for any new or existing task that needs to be scheduled; and
prevent task migration from a cool cluster to a warm cluster.

27. The non-transitory, tangible processor readable storage medium of claim 22, the instructions further comprising, when one or more of the plurality of processor clusters are cool clusters, one or more of the plurality of processor clusters are warm clusters, and one or more of the plurality of processor clusters are hot clusters:
selecting a cool cluster for any new or existing task that needs to be scheduled;
preventing task migration to a hot cluster;
preventing task migration from a cool cluster to a warm cluster; and
identifying a hottest cluster and initiating active task migration from the hottest cluster toward any cool cluster.
